(19) United States
(12) Patent Application Publication
(10) Pub. No.: US 2013/0327237 A1
(43) Pub. Date: Dec. 12, 2013

(54) SYSTEMS AND METHODS FOR IMPLEMENTING DIGITAL OFFSET LITHOGRAPHIC PRINTING TECHNIQUES

(71) Applicants: Nancy Y. JIA, Webster, NY (US); Augusto E. BARTON, Palo Alto, CA (US)

(72) Inventors: Nancy Y. JIA, Webster, NY (US); Augusto E. BARTON, Palo Alto, CA (US)

(73) Assignee: XEROX CORPORTATION, Norwalk, CT (US)

(21) Appl. No.: 13/494,098

(22) Filed: Jun. 12, 2012

(51) Int. Cl. B41F 7/02; B41F 3/34

(52) U.S. Cl. 101/217; 101/492

(57) ABSTRACT

A system and method are provided to implement variable data lithographic image forming in devices that are designed to maximize re-use of conventional offset lithographic image forming components, module and architectures. A truly variable data digital lithography scheme has been proposed as a departure from conventional offset lithography schemes. This disclosure introduces a system architecture to overcome limitations based on the architectural differences that make acceptance of the variable data lithographic scheme less practical and less attractive to some manufacturers and users. The disclosed systems and methods propose incorporating novel aspects of the true variable digital printing scheme into conventional offset lithographic modules and architectures. This disclosure describes re-use of conventional offset lithographic modules and/or architectures while making the disclosed systems and methods digital.

### BACKGROUND

1. Field of Disclosed Subject Matter

This disclosure relates to systems and methods that propose to maximize the re-use of conventional lithographic offset printing modules and architectures applying proposed digital marking methods and proposed variable digital offset architectures.

2. Related Art

Lithography is a common method of printing or marking images on an image receiving medium. In a typical lithographic process, the surface of a print image carrier, which may be a flat plate, cylinder or belt, is formed to have “image regions” of hydrophobic and oleophilic material, and “non-image regions” of a hydrophilic material. The image regions correspond to the areas on the final print on the image receiving medium that are occupied by a printing or marking material such as ink, whereas the non-image regions, e.g. background regions, are the regions corresponding to the areas on the final print on the image receiving medium that are not occupied by the printing or marking material. The hydrophilic regions accept, and are readily wetted by, a dampening fluid. The dampening fluid typically may consist of water and a small amount of alcohol, and may include other additives and/or surfactants that facilitate non-adherence of ink in those regions. The deposition of dampening fluid over the hydrophilic regions forms a fluid “release layer” for rejecting ink. Therefore, the hydrophilic regions of the printing plate correspond to unprinted areas, background areas, or “non-image areas” of the final print on the image receiving medium. The hydrophobic regions repel the dampening fluid and accept the ink.

Depending on a configuration of a conventional lithography system, the ink may be transferred directly to a substrate of image receiving medium, such as paper, or may be applied to an intermediate surface, such as an “offset” (or blanket) cylinder. This latter configuration is referred to as an offset lithographic printing system. The offset or blanket cylinder is covered with a conformable coating or sleeve with a surface that can conform to the surface topography of the image receiving medium or substrate, which may have surface peak-to-valley depth somewhat greater than the surface peak-to-valley depth of the imaging plate. Sufficient pressure is used to transfer the image from the offset or blanket cylinder to the image receiving substrate. The image receiving substrate is pinched between the offset or blanket cylinder and an impression cylinder that provides pressure against the offset or blanket cylinder to provide a transfer nip through which the image pattern on the offset/blanket cylinder is split transferred to the passing through image receiving substrate.

Conventional lithographic and offset lithographic printing techniques use plates that are permanently patterned, and are, therefore, generally considered to be useful only when printing a large number of copies of the same image in long print runs, such as for magazines, newspapers, and the like. These conventional processes are generally not considered amenable to creating and printing a new pattern from one page to the next because, according to known methods, removing and replacing of plates, including on a print cylinder, would be required in order to change images. For these reasons, conventional lithographic techniques cannot accommodate true high speed variable data printing in which the image changes from impression to impression, for example, as in the case of digital printing systems. Additionally, the cost of the permanently patterned imaging plates or cylinders is amortized over the number of copies of a document that are produced. The cost per printed copy is, therefore, higher for shorter print runs of the same image than for longer print runs of the same image, as opposed to prints from digital printing systems.

The lithography process provides very high quality printing at least in part due to the extremely high pigment loading and color gamut of the inks used. The inks, which typically have a high color pigment content, typically in a range of 20-70% by weight, enable low ink pile height images, typically between 1-2 microns and very low ink cost per image, compared to toners and many other types of printing or marking materials. This comparatively low cost generates a desire to use the lithographic and offset inks for printing or marking in order to take advantage of the high quality and low cost in a manageable manner if a system can be made amenable to printing variable image data from page to page. Previously, the number of hurdles to providing variable data printing using lithographic inks appeared insurmountable. Even the desire to reduce the cost per image for shorter print runs of the same image presented challenges. Ideally, the desire is to incur the same low cost per image of a long offset or lithographic print run, e.g., of more than 100,000 copies, for a medium print run, e.g., on the order of 10,000 copies, and for a short print run, e.g., on the order of 1,000 copies. Full implementation of a variable printing scheme using lithographic inks may ultimately result in the economies reaching the single copy print run in a true variable data printing system or method.

Efforts have been made to create lithographic and offset lithographic printing systems for variable data in the past. One example is disclosed in U.S. Pat. No. 3,800,699 in which an intense energy source such as a laser is used to pattern-wise evaporate a dampening fluid. In another example disclosed in U.S. Pat. No. 7,191,705, a hydrophilic coating is applied to an imaging belt. A laser selectively heats and evaporates or decomposes regions of the hydrophilic coating. A dampening fluid is then applied to these hydrophilic regions, rendering them oleophobic. Ink is then applied and selectively transferred onto the plate only in the areas not covered by dampening fluid, creating an inked pattern that can be transferred to an image receiving substrate. Once transferred, the imaging belt is cleaned, anew hydrophilic coating and dampening fluid are deposited, and the patterning, inking, and printing steps are repeated, for example for printing the next batch of images.

In yet another example disclosed in U.S. Patent Application Publication No. 2010-0251.914, a rewritable surface is used that can switch from hydrophilic to hydrophobic states without application of thermal, electrical or optical energy. Examples of these surfaces include the so-called switchable polymers and metal oxides such as ZnO₂ and TiO₂. After changing the surface state, dampening fluid selectively wets the hydrophilic areas of the programmable surface and, therefore, causes a rejection of the application of ink to these areas. These switchable coatings, particularly the switchable polymers, tend to be expensive to coat onto a surface and are typically prone to excessive wear. Also, these switchable coatings tend not to have the capacity to transform between hydrophobic and hydrophilic states in the sub-millisecond time range that would be required to enable high-speed variable data printing using lithographic techniques. Based on this, the effectiveness of using switchable coatings may be in limited short-run print projects rather than being adaptable to truly variable data high-speed digital lithography in which every impression can have a different image pattern changing from one print cycle to the next.

The above-described attempts at implementing variable data lithographic printing still suffered from numerous difficulties. For example, most imaging plate or belt surfaces using lithographic printing have a micro-roughened surface structure to retain dampening fluid in the non-imaging areas. The micro-roughened surface aids in retaining the liquid dampening fluid, enhancing an affinity toward the dampening fluid so that the liquid does not get forced away from the targeted surface locations by, for example, action at a nip. Shearing forces in the nip between the imaging surface and the ink forming cylinder can overwhelm any static or dynamic surface energy forces drawing dampening fluid to the surface.

A difficulty arises, however, in that these micro-roughened surfaces are difficult to clean by conventional mechanical means such as, for example, by using knife-edge cleaning systems for scraping residual ink from the plate or belt surface. The knife simply cannot get into the pits in the micro-roughened surface, which are there to effectively retain the dampening fluid. Additionally, physical contact between the knife and the plate or belt surface results in significant wear. Once the surface is worn, there is a relatively high cost of replacing a plate or belt. Non-contact cleaning processes, such as high-pressure rinsing or solvent cleaning are possible. These cleaning processes, however, tend to increase costs significantly, not only based on the inclusion of required additional subsystems, but also on a potential cost associated with hazardous waste disposal. Further, to date, these non-contact cleaning processes are of unproven effectiveness.

In an effort to improve cleaning on each pass, with an objective of providing ghost-free printing, the prior art systems describe using a very smooth belt or plate surface. See, e.g., U.S. Pat. No. 7,191,705 referenced above. Known techniques for cleaning the surface are more effective on these smooth surfaces. Physical scraping still has an effect of wearing the physical surface, but it is lessened. The difficulty with using smooth surfaces is that the advantage in being able to clean the smooth surface is offset with the reduced ability to retain a hydrophilic coating and printing or marking material as compared to the micro-roughened surface. So surfaces, therefore, may necessitate employing additional and costly subsystems such as, for example, surface energy conditioning subsystems including a corona discharge apparatus, which themselves can induce wear or damage to the plate or belt surface. Precise metering of the dampening fluid additionally can become more difficult without the presence of correct texture such as, for example, with the micro-roughened surface. Also, spreading or other lateral movement of the dampening fluid on a texture-free surface may compromise ultimate imaging resolution.

Another disadvantage encountered in attempting to modify conventional lithographic systems for variable printing is a relatively low transfer efficiency of the inks off of the imaging plate or belt. Common conventional lithographic and offset printing or marking processes operate with ink transfer on the order of approximately 50%, about half of the ink that is applied to the “reimageable” surface actually transfers to the image receiving substrate requiring that either the transfer efficiency be significantly improved or the other half of the ink be cleaned off the surface of the plate or belt and be removed. The relatively low transfer efficiency compounds the cleaning problem in that a significant amount of cleaning is required to completely clean off the ink from the surface of the plate or belt so as to avoid ghosting of one image onto another in variable data printing using a modification of conventional lithographic techniques. Also, unless the ink can be recycled without contamination, the effective cost of the ink is doubled. Traditionally, however, it is very difficult to recycle the highly viscous ink, thereby increasing the effective cost of printing and adding costs associated with ink disposal. Proposed systems fall short in providing high transfer efficiency, greater than 90% for example, to reduce ink waste and the associated costs. A balance must therefore be struck in the ink and material-surface designs to provide optimum spreading on a plate or belt surface including adequate separation between printing and non-printing areas, increased ability to transfer ink image to an image receiving substrate, and an ability to clean the ink in a manner that results in ghost-free prints and less wear on the plate or belt.

### SUMMARY OF THE DISCLOSED EMBODIMENTS

In order to address the above-identified shortfalls, U.S. patent application Ser. No. 13/095,714 (the 714 application), which is commonly assigned and the disclosure of which is incorporated by reference herein in its entirety, proposes systems and methods for providing variable data lithographic printing. The systems and methods disclosed in the 714 application are directed to improvements on various aspects of previously-attempted variable data imaging lithographic marking concepts based on variable patterning of dampening fluid, to achieve effective truly variable digital data lithographic printing.

According to the 714 application, a reimageable surface is provided on an imaging member, which may be a drum, plate, Cylinder, belt or the like. The reimageable surface may be composed of, for example, a class of materials commonly referred to as silicones, including polydimethylsiloxane (PDMS) among others. The reimageable surface may be formed of a relatively thin layer over a mounting layer, a thickness of the relatively thin layer being selected to balance printing or marking performance, durability and manufacturability.

The 714 application describes, in requisite detail, an exemplary variable data lithography system 100 such as that shown, for example, in FIG. 1. A general description of the exemplary system 100 shown in FIG. 1 is provided here. Additional details regarding individual components and/or subsystems shown in the exemplary system 100 of FIG. 1 may be found in the 714 application.

As shown in FIG. 1, the exemplary system 100 may include an imaging member 110. The imaging member 110 in the embodiment shown in FIG. 1 is a cylinder, but this exemplary depiction should not be read in a manner that precludes the imaging member 110 being a plate or a belt, or of another known configuration. The imaging member 110 is used to apply an ink image to an image receiving substrate 114 at a nip 112. The nip 112 is produced by an impression cylinder 118, as part of an image transfer mechanism 160, exerting pressure in the direction of the imaging member 110. Image receiving substrate 114 should not be considered to be limited to any particular composition such as, for example, paper, plastic or composite sheet film. The exemplary system 100 may be used for producing images on a wide variety of image receiving substrates. The 714 application also explains the wide latitude of marking (printing) materials that may be used including marking materials with pigment densities greater than 10% by weight. As does the 714 application, this disclosure will use the term ink to refer to a broad range of printing or marking materials to include those which are commonly understood to be inks and other materials which may be applied by the exemplary system 100 to produce an output image on the image receiving substrate 114.

The 714 application depicts and describes details of the imaging member 110 including the imaging member 110 being comprised of a reimageable surface layer formed over a structural mounting layer.

The exemplary system 100 includes a dampening fluid subsystem 120 for uniformly wetting the reimageable surface of the imaging member 110 with dampening fluid. A purpose of the dampening fluid subsystem 120 is to deliver a layer of dampening fluid, generally having a uniform and controlled thickness, to the reimageable surface of the imaging member 110. As indicated above, it is known that the dampening fluid may comprise water optionally with small amounts of isopropyl alcohol or ethanol added to reduce surface tension as well as to lower evaporation energy necessary to support subsequent laser patterning, as will be described in greater detail below. Small amounts of certain surfactants may be added to the dampening fluid as well. It should be recognized that, although the dampening fluid is described in the 714 application as being water-based, it should not be considered to be so limited.

Once the dampening fluid is metered onto the reimageable surface of the imaging member 110, a thickness of the dampening fluid may be measured using a sensor 125 that may provide feedback to control the metering of the dampening fluid onto the reimageable surface of the imaging member 110 by the dampening fluid subsystem 120.

Once a precise and uniform amount of dampening fluid is provided by the dampening fluid subsystem 120 on the reimageable surface of the imaging member 110, and optical patterning subsystem 130 may be used to selectively form a latent image in the uniform dampening fluid layer by image-wise patterning the dampening fluid layer using, for example, laser energy. The reimageable surface of the imaging member 110 should ideally be designed to absorb most of the laser energy emitted from the optical patterning subsystem 130 close to its surface to minimize energy wasted and to minimize lateral spreading of heat in order to maintain a high spatial resolution capability. Alternatively, an appropriate radiation sensitive component may be added to the dampening fluid to aid in the absorption of the incident radiant laser energy. While the optical patterning subsystem 130 is described above as being a laser emitter, it should be understood that a variety of different systems may be used to deliver the optical energy to pattern the dampening fluid.

The mechanics at work in the patterning process undertaken by the optical patterning subsystem 130 of the exemplary system 100 are described in detail with reference to FIG. 5 in the 714 application. Briefly, the application of optical patterning energy from the optical patterning subsystem 130 results in image-wise evaporation of the layer of dampening fluid.

Following patterning of the dampening fluid layer by the optical patterning subsystem 130, the patterned layer over the reimageable surface of the imaging member 110 is presented to an inker subsystem 140. The inker subsystem 140 is used to apply a uniform layer of ink over the patterned layer of dampening fluid on the reimageable surface layer of the imaging member 110. The inker subsystem 140 may use an anilox cylinder to meter an lithographic ink onto one or more ink forming cylinders that are in contact with the reimageable surface layer of the imaging member 110. Separately, the inker subsystem 140 may include other traditional elements such as a series of metering cylinders to provide a precise feed rate of ink to the reimageable surface. The inker subsystem 140 may deposit the ink to the pockets representing the imaged regions of the reimageable surface, while ink applied on the regions with dampening fluid will not adhere based on the hydrophobic and/or oleophobic nature, of those regions.

The cohesion and viscosity of the ink image pattern residing in the reimageable layer of the imaging member 110 may be modified by a number of mechanisms. One such mechanism may involve the use of a rheology (complex viscoelastic modulus) control subsystem 150. The rheology control system 150 may form a partial crosslinking core of the ink on the reimageable surface to, for example, increase the cohesion of the ink relative to adhesion of the ink to the reimageable surface. The ink pre-conditioning mechanisms may include optical or photo curing, heat curing, drying, or various forms of chemical curing. Cooling may be used to modify rheology as well via multiple physical cooling mechanisms, as well as via chemical cooling.

The ink is then transferred from the reimageable surface of the imaging member 110 to an image receiving substrate 114 using a transfer subsystem 160. The transfer occurs as the substrate 114 is passed through a nip 112 between the imaging member 110 and an impression member 118 such that the ink on the reimageable surface of the imaging member 110 is brought into physical contact with the substrate 114. With the cohesion and adhesion of the ink having been optionally modified by the rheology control system 150, modified ink causes the ink to adhere to the image receiving substrate 114 and to separate from the reimageable surface of the imaging member 110 with minimal ink offset. Careful control of the temperature and pressure conditions at the nip 112 may allow transfer efficiencies for the ink from the reimageable surface of the imaging member 110 to the image receiving substrate 114 to exceed 90%. While it is possible that some dampening fluid may also wet the image receiving substrate 114, the volume of such a dampening fluid will be minimal, and will rapidly evaporate or be absorbed by the image receiving substrate 114.

Following the transfer of the majority of the ink to the image receiving substrate 114, any residual ink and/or residual dampening fluid must be removed from the reimageable surface of the imaging member 110, preferably without scraping or wearing that surface. An air knife 175 may be employed to remove residual dampening fluid. It is anticipated, however, that some amount of ink residue may remain. Removal of such remaining ink residue may be accomplished through use of some form of cleaning subsystem 170. The 714 application describes details of such a cleaning subsystem 170 including at least a first cleaning member such as a sticky or tacky member in physical contact with the reimageable surface of the imaging member 110, the sticky or tacky member removing residual ink and any remaining small amounts of surfactant compounds from the dampening fluid of the reimageable surface of the imaging member 110. The sticky or tacky member may then be brought into contact with a smooth cylinder to which residual ink may be transferred from the sticky or tacky member, the ink being subsequently stripped from the smooth cylinder by, for example, a doctor blade.

The 714 application details other mechanisms by which cleaning of the reimageable surface of the imaging member 110 may be facilitated. Regardless of the cleaning mechanism, however, cleaning of the residual ink and dampening fluid from the reimageable surface of the imaging member 110 is essential to preventing ghosting in the proposed system. Once cleaned, the reimageable surface of the imaging member 110 is again presented to the dampening fluid subsystem 120 by which a fresh layer of dampening fluid is supplied to the reimageable surface of the imaging member 110, and the process is repeated.

According to the above proposed architecture, variable data digital lithography has attracted attention in producing truly variable digital images in a lithographic image forming system. The above-described architecture combines the functions of the imaging plate and potentially a transfer blanket into a single imaging member 110. Based on this departure from conventional offset lithography architectures, re-use of those existing conventional offset lithography architectures, and existing modules, is limited. This architectural difference may make acceptance of the above-proposed architecture less practical and less attractive for large press makers. There are a number of surplus conventional offset presses that could potentially be remanufactured into variable data offset lithographic presses, but not with only the above-proposed architecture. In addition, the above-proposed architecture is, in many ways, singularly unique. Integration of subsets of the above digital re-imaging concepts into conventional offset lithographic printing presses may benefit manufacturers and users of such devices based on availability of component structures and familiarity with operation of the legacy offset lithographic presses.

Exemplary embodiments of the disclosed systems and methods propose incorporating novel aspects of the true variable digital printing processes described above into conventional offset lithographic modules and architectures.

Exemplary embodiments propose to maximize the re-use of the conventional offset lithographic modules and/or architectures while making the disclosed systems and methods digital using the methods applied in the currently-proposed digital lithography architecture described above and additional methods to enable the re-use of the conventional offset lithographic image forming architectures.

Exemplary embodiments are based on an understanding that the currently-proposed digital architecture, as described in detail above, is different from conventional offset lithographic presses. The typical offset lithographic press architecture builds fixed ink images, not variable data, on the hard plate cylinder and then the ink image is transferred to a conformable blanket cylinder surface. The ink image is then further transferred from the blanket cylinder surface to the image receiving substrate under controlled conditions that maximize the image quality of the final images formed on the substrate. The common offset lithographic press architectures in the market possess this typical arrangement while the currently-proposed digital lithography architecture lacks a large degree of commonality with the conventional offset presses. Conventional offset lithographic press architectures cannot be transformed to digital by simply switching the plate cylinder. In most of the conventional offset lithographic presses, the blanket cylinder has a same diameter as the plate cylinder so that the repetitive image always ends up on an exact same spot as it is transferred from the plate cylinder to the blanket cylinder to avoid ghosting issues. When printing digital images, the image can change for every revolution of the modified plate cylinder and any remaining ink on the blanket cylinder, in addition to the remaining ink on the modified plate cylinder, would lead to ghosting. The same problem occurs when employing an ink transfer cylinder since areas that transfer ink from the ink transfer cylinder to the modified plate cylinder will have a bit less ink on the following revolution leading to potential ghosting issues as well. These issues may be addressed in the systems and methods according to this disclosure for integrating digital concepts into conventional offset lithographic devices with the inclusion of multiple cleaning elements associated with each of the major cylinder components in the devices.

Exemplary embodiments may provide cleaners at several different stages/locations to remove any traces of inks, dampening fluids or paper debris on the blanket cylinder, the modified plate cylinder, referred to in this disclosure as a Digital Offset Plate (DOP) cylinder or the ink transfer cylinder.

Exemplary embodiments may provide that almost all of the formed ink images on the DOP cylinder and the blanket cylinder, e.g., in excess of 90%, are transferred. Nevertheless, the DOP cylinder and the blanket cylinder may separately require cleaning in order to eliminate ghosting.

In exemplary embodiments, an amount of ink removed from an ink transfer cylinder may be substantially larger than an amount of ink removed from either of a DOP cylinder or a blanket cylinder. As such, re-circulation of the ink removed from the ink cylinder may be facilitated using, for example a collection hopper that could collect the ink and include means of feeding the ink back to an ink chamber for re-use. In embodiments, alternative transport mechanisms may be implemented. An exemplary hopper may include augers and/or one or more pumps to facilitate the disclosed ink re-circulation.

Exemplary embodiments may provide a specific cleaner design which has a tacky cylinder to remove the ink followed by an oleophilic (anti-ink) cylinder from which the ink is doctored off. Many other cleaner designs are anticipated, however.

Exemplary embodiments may provide a DOP cylinder surface with the top most layer made of some type of silicone, including polydimethylsiloxane (PDMS) and fluorosilicone among others. The top most layer may be thin and relatively stiff as DOP conformance to an image receiving substrate is not required in this proposed architecture, unlike in the architecture proposed in the 714 application. Optionally, the DOP surface may have structured or unstructured texture to control the quality of the dampening fluid and ink image formation, and to enable high-efficiency transfer of inked images from DOP cylinder to the blanket cylinder. The blanket cylinder may include a surface of smooth, conformable, thick silicone-like materials, together with the above-mentioned DOP material design, to enable high-efficiency and high fidelity ink transfer from the DOP cylinder to the blanket cylinder and then, in turn, from the blanket cylinder to all types of image receiving substrates including coated and uncoated papers, heavy stocks, rough substrates, woods, plastics and the like.

In embodiments, the DOP cylinder and/or the blanket cylinder may be pre-heated prior to the DOP cylinder and blanket cylinder nip, or at the nip, to assist/improve high-efficiency ink image transfer.

Exemplary embodiments may include multiple variable data offset lithographic modules for producing multi-color images on image receiving substrates. The color images may be pre-conditioned or pre-cured in between the color modules prior to entering a subsequent color module.

These and other features, and advantages, of the disclosed systems and methods are described in, or apparent from, the following detailed description of various exemplary embodiments.

### BRIEF DESCRIPTION OF THE DRAWINGS

Various exemplary embodiments of the disclosed systems and methods for implementing variable digital printing or marking in conventional offset lithographic printing or marking systems will be described, in detail, with reference to the following drawings, in which:

FIG. 1 illustrates a schematic representation of a proposed variable data lithographic printing system;

FIG. 2 illustrates a schematic representation of a conventional offset lithographic printing system;

FIG. 3 illustrates a schematic representation of an exemplary modified offset lithographic printing module including numerous variable data lithographic printing system elements according to this disclosure;

FIG. 4 illustrates a first exemplary embodiment of a four-color variable data lithographic system including multiple exemplary modified offset lithographic printing modules according to the disclosed systems and methods;

FIG. 5 illustrates a second exemplary embodiment of a four-color variable data lithographic system including multiple exemplary modified offset lithographic printing modules according to the disclosed systems and methods; and

FIG. 6 illustrates a flowchart of an exemplary method for implementing variable data lithographic printing in a modified offset lithographic printing module according to this disclosure.

### DETAILED DESCRIPTION OF TILE DISCLOSED EMBODIMENTS

The systems and methods for implementing variable data offset lithographic printing in systems and according to methods that reuse portions of conventional offset lithographic architectures according to this disclosure will generally refer to this specific utility or function for those systems and methods. Exemplary embodiments described and depicted in this disclosure should not be interpreted as being specifically limited to any particular configuration of the described elements, or as being specifically directed to any particular intended use. Any advantageous combination of legacy offset lithographic printing or media marking elements and variable data lithography elements that will result in high quality output lithographic images and elimination of ghosting are contemplated as being included in this disclosure.

Specific reference to, for example, a conventional offset lithographic printing device, or a proposed variable data lithographic printing device should not be considered as being limited to any particular configuration of those respective devices, as described. The terms “image forming device,” “offset lithographic printing system,” “offset lithographic marking device/system,” “offset lithographic printing press,” and the like, as referenced throughout this disclosure are intended to refer globally to a class of devices and systems that carry out what are generally understood as lithographic printing functions as those functions would be familiar to those of skill in the art.

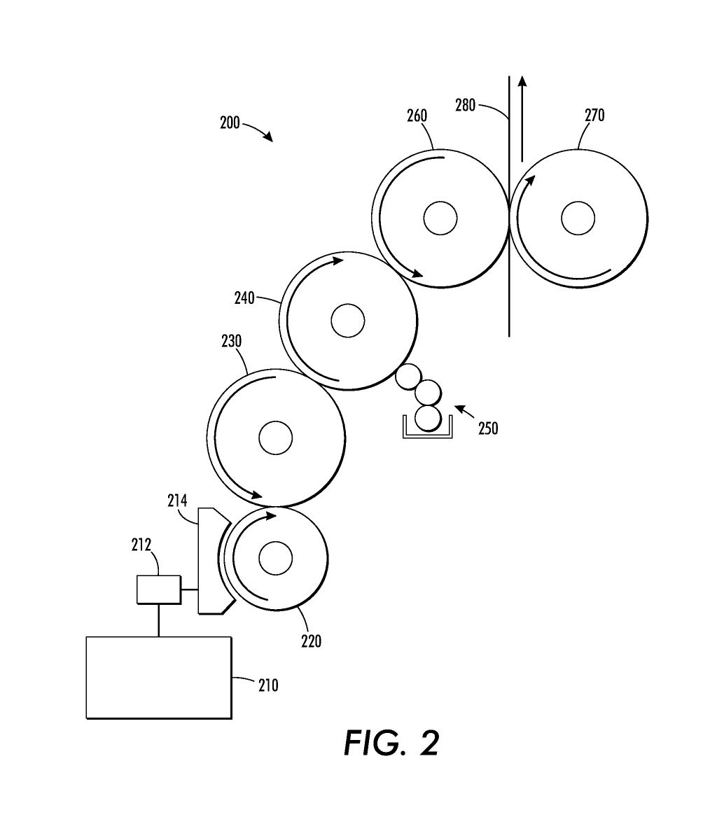

FIG. 2 illustrates a schematic representation of a conventional offset lithographic printing system 200. As shown in FIG. 2, an inking system may include an ink reservoir 210, an ink pump 212 and an ink chamber 214 that cooperate to deposit viscous lithographic ink on an anilox cylinder 220.

Anilox is recognized by those of skill in the art to refer to a class of inking methods and related inking systems used to provide a measured amount of ink to an ink form cylinder 230. Generally, an anilox cylinder 220 may be configured, for example, as a hard cylinder that may have a metal core and may be coated with a material, such as a ceramic material, that produces an ink carrying and/or ink transferring surface containing very fine pockets or cells. The anilox cylinder 220 may be partially submerged in an ink fountain such as that provided by ink chamber 214. A thick layer of the viscous lithographic liquid may be deposited on the anilox cylinder 220. A doctor blade (not shown) may be used to scrape excess ink from the surface of the anilox cylinder 220 leaving the measured amount of ink only in the cells. The anilox cylinder 220 may then rotate to contact the ink form cylinder 230, which in turn may contact the plate cylinder 240. A lithographic printing plate may be disposed on the plate cylinder 240 as the imaging surface of the plate cylinder 240. The ink form cylinder 230 may thus be used to split transfer the measured amount of ink from the anilox cylinder 220 to the ink form cylinder 230, and then from ink form cylinder 230 to the imaging surface of the plate cylinder 240.

A dampening unit 250 may be used to provide a dampening fluid on the imaging surface of the plate cylinder 240 in order to variably condition imaging and non-imaging areas of the lithographic printing plate disposed on the plate cylinder 240 as the imaging surface prior to the introduction of the ink from the ink form cylinder 230 to the imaging surface of the plate cylinder 240.

The imaging surface of the plate cylinder 240 may receive the ink from the ink form cylinder 230 and may transfer an ink image to an offset blanket cylinder 260. The blanket cylinder 260 then may cooperate with the impression cylinder 270 to form a nip through which the ink image is transferred from the blanket cylinder 260 to the image receiving substrate 280. Efficiencies of ink, and therefore ink image, transfer from the blanket cylinder 260 to the image receiving substrate 280 may be affected by modifying the interaction between the blanket cylinder 260 and the impression cylinder 270, including controlling temperature and pressure at the nip.

As noted briefly above, in a conventional offset lithography system, such as that schematically illustrated in FIG. 2, the blanket cylinder 260 and the plate cylinder 240 will generally have a common diameter such that the ink image is repeatedly applied to a same position on the surface of the blanket cylinder 260 to prevent ghosting.

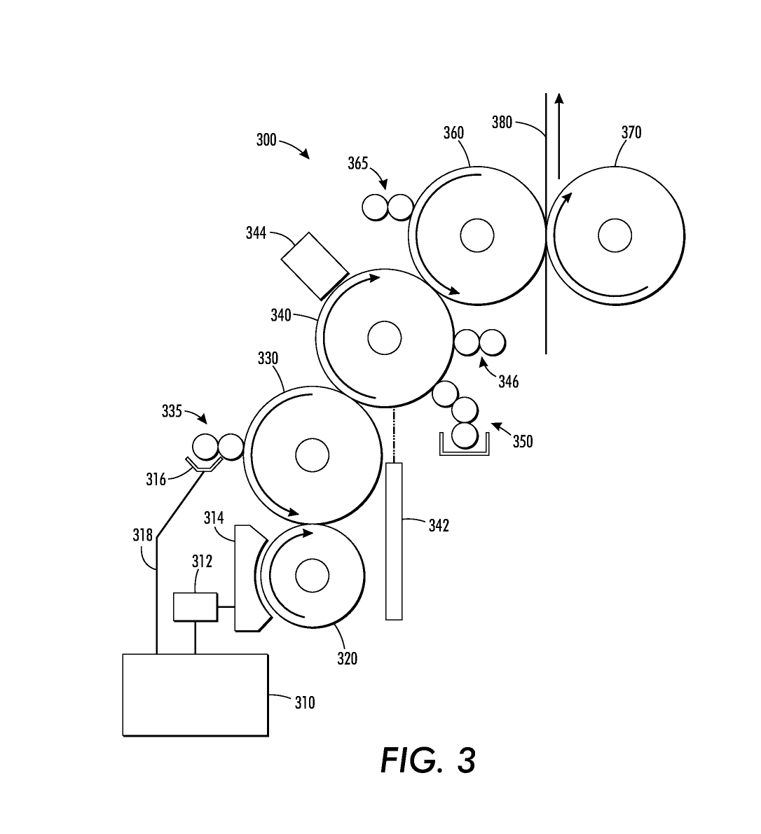

FIG. 3 illustrates a schematic representation of an exemplary modified offset lithographic printing module 300, including numerous variable data lithographic printing subsystem elements, according to this disclosure to enable variable-data offset lithographic printing. As shown in FIG. 3, a number of modifications are proposed to the conventional offset lithographic printing system 200 shown in FIG. 2. A common numbering scheme is used, where applicable, for the common elements shown in FIGS. 2 and 3 in order to highlight those elements that are generally common between the system shown in FIG. 2 and the exemplary module 300 shown in FIG. 3. In other words, the ink reservoir 3W, the ink pump 312 and the ink chamber 314 may generally correspond in form and function to the corresponding elements 210,212,214 shown in FIG. 2. In like manner, the blanket cylinder 360, the impression cylinder 370 and the image receiving substrate 380 may include similar forms and functions to those discussed above for the respective elements of the conventional system 200 shown in FIG. 2. Specific modifications to the conventional system 200 shown in FIG. 2 to arrive at the configuration of the exemplary module 300 shown in FIG. 3 are detailed below.

According to the exemplary embodiment 300 shown in FIG. 3, the anilox cylinders 320, the ink forming cylinder 330, and the dampening unit 350 might be modified to enable the ghost-free variable data printing. Optionally, the anilox cylinder 320 might be in direct contact with the plate cylinder 340 with the elimination of the ink forming cylinder 330 to enable ghost-free transfer. The dampening fluid itself and delivering method could also be different in order to accommodate the variable data printing needs.

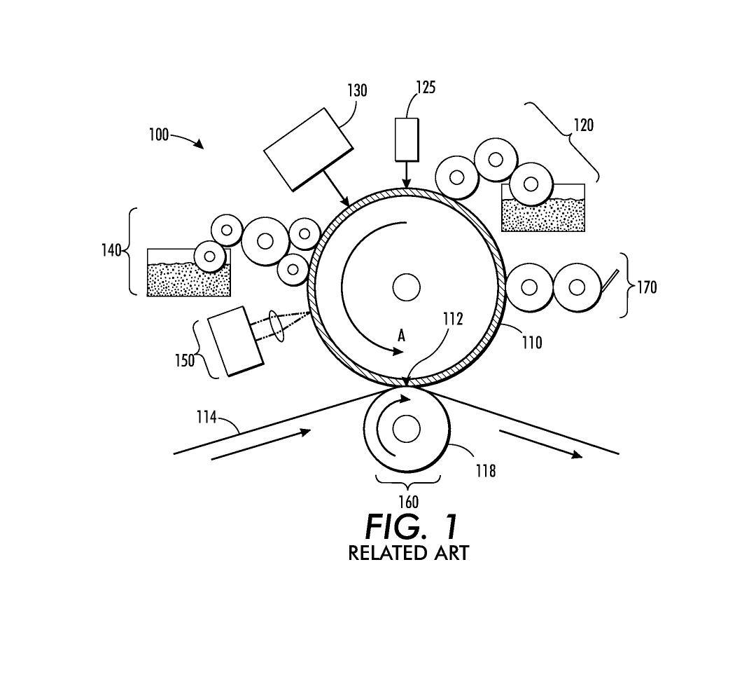

According to the exemplary embodiment 300 shown in FIG. 3, the plate cylinder may be provided with a digital offset plate (DOP) as an imaging surface on a DOP cylinder 340. The DOP cylinder 340 may exhibit some characteristics such as those discussed above regarding the reimageable surface of the imaging member 110 in the architecture shown in FIG. 1, but is different. The top layer of the DOP cylinder 340 may be formed of a type of silicone including polydimethylsiloxane (PDMS) and fluorosilicone among others, it is thin and relatively stiff as DOP conformance to a substrate is not required in this proposed architecture, different from the structure disclosed in the 714 application. Optionally, the DOP surface might have structured or unstructured texture to control the quality of the dampening fluid and ink image formation, and to enable high-efficiency transfer of inked images from the DOP cylinder 340 to the blanket cylinder 360. The blanket cylinder 360 may include a surface of Smooth, conformable, thick silicone-like materials, together with the above-mentioned DOP material design, to enable high-efficiency in high fidelity ink transfer, e.g., in excess of 90%, from the surface of the DOP cylinder 340 to the surface of the blanket cylinder 360 and then, in turn, from the surface of the blanket cylinder 360 to all type of substrates, such as the exemplary image receiving substrate 380 shown in FIG. 3. Exemplary image receiving substrates 380 may include, for example, coated and uncoated papers, heavy stocks, rough substrates, woods, fabrics, plastics and the like. In embodiments, the disclosed transfer efficiencies may be enhanced by applying heat prior to and/or in the nip formed between the DOP cylinder 340 and the blanket cylinder 360. Heat and pressure control at the nip may be according, to known heat-assisted transfer methods employed, for example, in U.S. Pat. No. 6,088,565 for controlling ink transfer.

An optical patterning unit 342 may be added to produce optical patterned images in a dampening fluid bathed surface of the DOP cylinder 340. The optical patterning unit 342 may comprise a laser patterning device for projecting laser energy onto the reimagaeable surface, according to the methods described above, of the DOP cylinder 340. As shown in FIG. 3, the optical patterning unit 342 may be positioned to pattern the reimageable surface of the DOP cylinder 340 downstream of a dampening unit 350 once an amount of dampening fluid has been evenly distributed on the reimageable surface of the DOP cylinder 340 and prior to the patterned surface of the DOP cylinder 340 passing through a nip formed between the DOP cylinder 340 and the ink forming cylinder 330 where the ink is deposited uniformly on the patterned reimageable surface of the DOP cylinder 340. The diameter of the DOP cylinder 340 may be the same as the diameter of the blanket cylinder 360.

A rheology (ink viscosity) control or conditioning unit 344 such as, for example, a UV partial cure unit, may be provided downstream of the nip formed between the DOP cylinder 340 and the ink forming cylinder 330. The rheology control unit 344 may modify the cohesion and/or viscosity of the ink residing in the patterned reimageable surface of the DOP cylinder 340 according to any of the known mechanisms discussed above.

A first cleaning unit 346 may be added downstream of the nip formed between the DOP cylinder 340 and the blanket cylinder 360 to specifically clean residual ink from the DOP cylinder 340 once the DOP cylinder 340 has efficiently transferred the inked image on the surface of the blanket cylinder 360. Cleaning of all of the inked surfaces in the exemplary module 300 may be appropriate to reduce and/or eliminate the possibility of ghosting. A second cleaning unit 365 may be provided downstream of a nip formed between the blanket cylinder 360 and the impression cylinder 370 through which the image receiving substrate 380 passes to receive the inked image from the blanket cylinder 360. The ink transfer from the DOP cylinder 340 to the blanket cylinder 360, and from the blanket cylinder 360 to the image receiving substrate 380, may be controlled to an efficiency rate of higher than 90%. The first cleaning unit 346 and the second cleaning unit 365 may have a configuration as described above with regard to cleaning subsystem 170 shown in FIG. 1. The first cleaning unit 346 and the second cleaning unit 365 may include a first cleaning member such as a sticky or tacky member in physical contact with the surface of the respective cylinder and/or cylinder from which the ink is to be removed. The sticky or tacky member may be brought into contact with a smooth cylinder to which residual ink may be transferred from the sticky or tacky member, the ink being subsequently stripped from the smooth cylinder by, for example, a doctor blade according to known methods.

Alternatively, the first and second cleaning units 346,365 may include a first cleaning blade, air knife, followed by the sticky or tacky member. The first cleaning unit 346 and the second cleaning unit 365 may be used to remove any trace of ink, dampening fluid and/or paper debris on the DOP cylinder 340 and the blanket cylinder 360.

A third cleaning unit 335 may be provided in contact with the ink forming cylinder 330. A different configuration to the third cleaning unit 335 may be appropriate. An amount of ink to be removed from the ink forming cylinder 330 by the third cleaning unit 335 may be substantially larger based on an expected efficiency of ink split transfer from the ink forming cylinder 330 to the DOP cylinder 340 being typically in a range of about 50%. Re-circulation of the higher amounts of ink recovered from the surface of the ink forming cylinder 330 by the third cleaning unit 335 may be appropriate. A configuration, therefore, of the third cleaning unit 335 may be augmented to include some form of a hopper 316 that could be used to collect the mass of ink removed by the third cleaning unit 335 from the ink form cylinder 330. The hopper 316 may be in fluid communication with ink reservoir 310 by one or more fluid flow paths 318 through which ink removed from the ink forming cylinder 330, and collected in the hopper 316, may be recycled to the ink reservoir 310 for reuse. It should be understood that no particular configuration to this ink return means is necessarily indicated by this disclosure. Many different alternatives to transport the ink may be implemented between the hopper 316 and the ink reservoir 310. Also, the hopper 316 may itself include augers and/or some configuration of a pumping mechanism such as, for example, one or more ink pumps (not shown) provided in or with the hopper 316 to facilitate ink flow back to the ink reservoir 310 without stagnation.

This discussion is not intended to limit the third cleaning unit 335 to any specific cleaner design. It should be recognized that there are many other cleaner alternatives that could be proposed as being known to those of skill in the art.

Various architectures that include two or more modified offset lithographic printing modules including variable data lithographic printing system elements are also proposed.

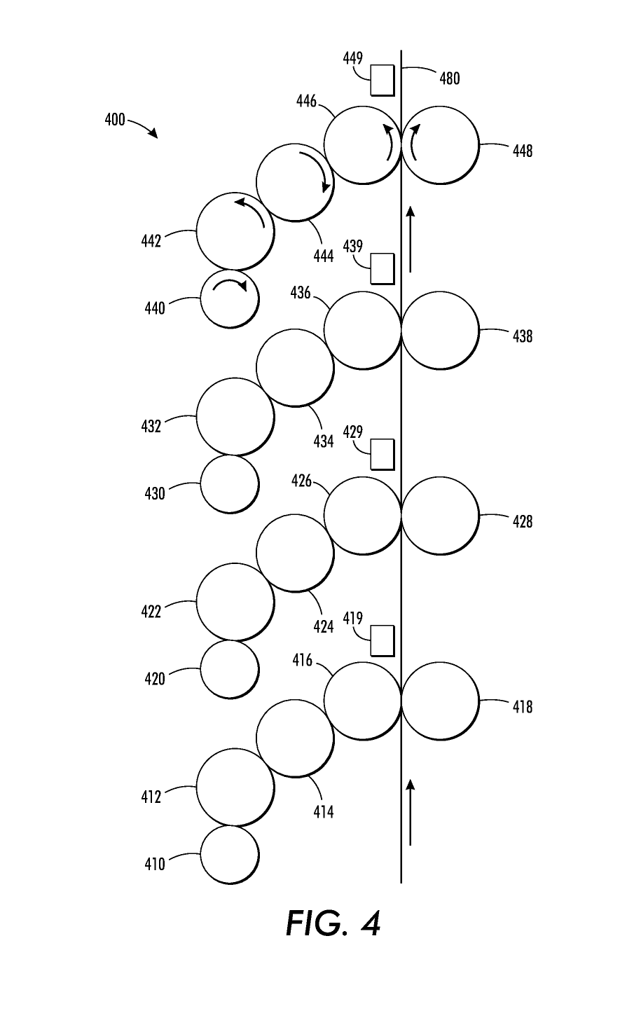

FIG. 4 illustrates a first exemplary embodiment of a four or more color variable data lithographic system 400 including multiple modified offset lithographic printing modules as described above and depicted in FIG. 3. Certain of the detailed elements of the exemplary module shown in FIG. 3 are eliminated for clarity of the depiction in FIG. 4. These elements should be understood to be included in one or more of the exemplary modules shown in FIG. 4.

As shown in FIG. 4, the exemplary four or more color variable data lithographic system 400 may include multiple individual modules, each module constituted of an anilox cylinder 410,420,430,440; at least one ink form cylinder 412,422,432,442; a DOP cylinder 414,424,434,444; a blanket cylinder 416,426,436,446; and an impression cylinder 418,428,438,448, each module being essentially constituted additionally with the details shown in the exemplary module 300 shown in FIG. 3. Each of the various modules may be used to deposit a different color of an identical or variable inked image on the substrate 480. Image conditioning, partial curing, or curing system 419,429,439,449 may be used to partially cure or cure the image after each color to avoid across color contamination and to obtain the final cured image.

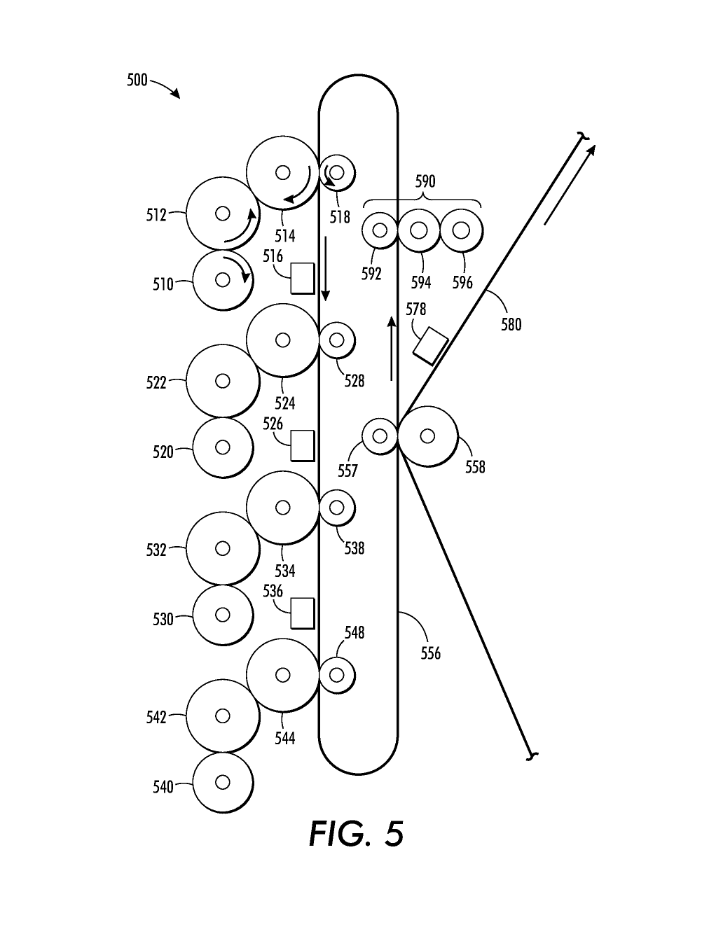

FIG. 5 illustrates a second exemplary embodiment of a four-color variable data lithographic system 500 including multiple modified offset lithographic printing modules as described above and depicted in FIG. 3. Certain of the detailed elements of the exemplary module shown in FIG. 3 are eliminated for clarity of the depiction in FIG. 5. These elements should be understood to be included in one or more of the exemplary modules shown in FIG. 5.

As shown in FIG. 5, the exemplary four-color variable data lithographic system 500 may include multiple individual modules, each module constituted of an anilox cylinder 510,520,530,540; at least one ink form cylinder 512,522,532,542; a DOP cylinder 514,524,534,544; and an impression cylinder 518,528,538,548, each module being essentially constituted additionally with the details shown in the exemplary module 300 shown in FIG. 3, except as specifically modified according to the discussion below. Image conditioning or partial curing system 516,526,536 may be used to prevent re-transfer and across color contamination and a final curing system 578 may be used to cure the final image.

A difference between the first embodiment 400 shown in FIG. 4 and the second embodiment 500 shown in FIG. 5 is the replacement of the individual blanket cylinder associated with each module with a single blanket or intermediate transfer belt 556. Each of the various modules may be used to deposit a different color of an identical or variable inked image on the blanket belt 556. The image on the blanket belt 556 is then transferred with high efficiency to an image receiving substrate 580 through an image transfer nip formed between an opposing pair of impression cylinders 557,558 associated with the intermediate blanket belt 556. Additional support and/or drive cylinders that may be employed to support and/or drive the intermediate blanket belt 556. Details of these additional cylinders are omitted for simplicity and clarity of the elements shown in FIG. 5.

A fourth cleaning unit 590 may be provided downstream of the image transfer nip to clean residual ink and/or other debris from the imaging surface of the intermediate blanket belt 556 after the inked image is transferred to the to the image receiving substrate 580 at the image transfer nip. The cleaning unit 590 may include a pressure cylinder 592, a sticky or tacky cylinder 594 and a smooth cylinder 596 or some other configurations, as discussed above.

The first and second exemplary embodiments 400,500 shown in FIGS. 4 and 5 are intended only to provide examples of variations in modified system architecture that may be used to implement variable data lithography by reusing at least elements and/or components of conventional offset lithographic printing or image path control systems. Those of skill in the art will recognize that differing configurations of module elements, including for example retaining multiple blanket cylinders for the transfer of inked images to a single intermediate imaging belt, or employing differing numbers of individual modules with the same or different color inks, may be included without departing from the spirit and scope of the disclosed systems.

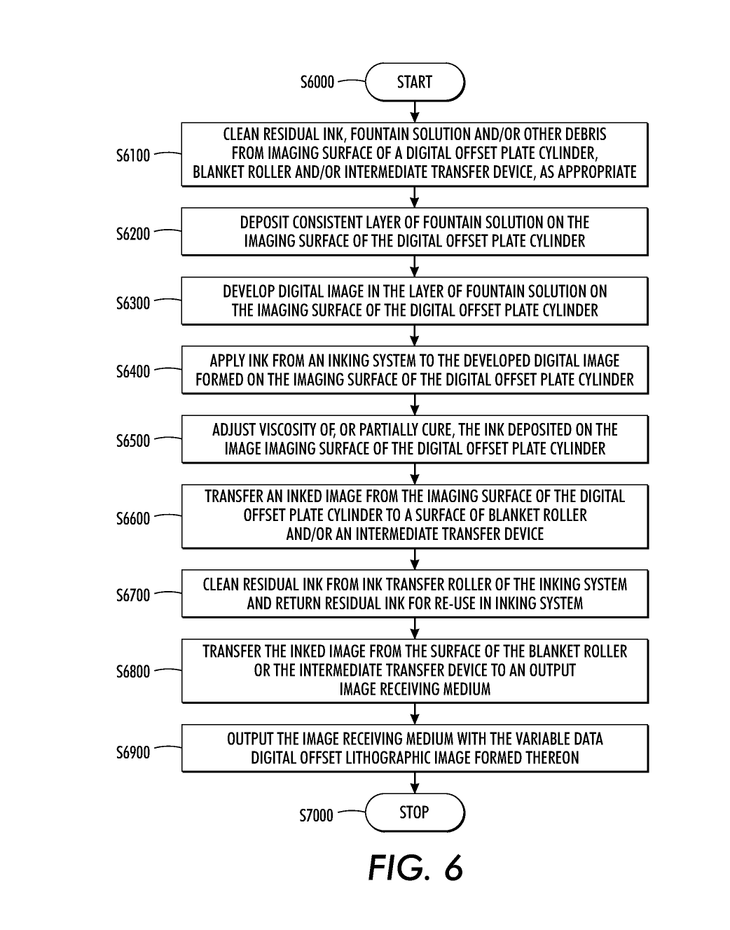

The disclosed embodiments may include methods for implementing variable data lithographic printing in one or more modified offset lithographic printing modules. FIG. 6 illustrates a flowchart of such an exemplary method. As shown in FIG. 6, operation of the method commences at Step S6000 and proceeds to Step S6100.

In Step S6100, residual ink, dampening fluid and/or other debris, including for example, paper or substrate debris, may be removed from surfaces of a DOP cylinder, a blanket cylinder (also or alternatively, as appropriate on an intermediate transfer blanket belt) in preparation for a variable data lithographic cycle in a variable data offset lithographic system. Operation of the method proceeds to Step S6200.

In Step S6200, a consistent layer of dampening fluid may be deposited on the imaging surface of the DOP cylinder. Operation of the method proceeds to Step S6300.

In Step S6300, a digital image may be developed in the layer of dampening fluid deposited on the imaging surface of the DOP cylinder using an optical imaging device such as a laser imaging device. Operation of the method proceeds to Step S6400.

In Step S6400, an ink layer may be applied to the developed dampening fluid digital image on the DOP cylinder from an inking system. Operation of the method proceeds to Step S6500.

In Step S6500, the viscosity or cohesion of the ink image on the imaging surface of the DOP cylinder may be increased by using, for example, a rheology adjusting system that may pre-condition or partially cure the deposited ink to maximize the ink transfer efficiency from the DOP cylinder to at least one of a blanket cylinder or an intermediate transfer blanket belt. Operation of the method proceeds to Step S6600.

In Step S6600, the inked image may be transferred from the imaging surface of the DOP cylinder to at least one of the blanket cylinder or the intermediate transfer blanket belt. Operation of the method proceeds to Step S6700.

In Step S6700, residual ink may be cleaned from the ink forming cylinder of the inking system. The cleaned residual ink may be returned to an ink reservoir in the inking system for re-use. Operation of the method proceeds to Step S6800.

In Step S6800, the inked image may be transferred from the surface of the blanket cylinder or the intermediate transfer blanket belt to an output image receiving substrate. The image may be partially cured in-between the color stations and the final image may be cured. Operation of the method proceeds to Step S6900.

In Step S6900, the image receiving substrate, with the variable data Digital offset lithographic image formed thereon, may be output. Operation of the method proceeds to Step S7000, where operation of the method ceases.

The above-described exemplary systems and methods reference certain conventional components to provide a brief, general description of suitable image forming means by which to carry out variable data lithographic image forming in a system using legacy offset lithographic elements including one or more of a blanket cylinder or an intermediate transfer blanket belt.

Those skilled in the art will appreciate that other embodiments of the disclosed subject matter may be practiced with many types of image forming elements common to lithographic systems in many different configurations.

The exemplary depicted sequence of executable instructions represents one example of a corresponding sequence of acts for implementing the functions described in the steps. The exemplary depicted steps may be executed in any reasonable order to carry into effect the objectives of the disclosed embodiments. No particular order to the disclosed steps of the method is necessarily implied by the depiction in FIG. 6, and the accompanying description, except where a particular method step is a necessary precondition to execution of any other method step. Individual method steps may be carried out in sequence or in parallel in simultaneous or near simultaneous timing

Although the above description may contain specific details, they should not be construed as limiting the claims in any way. Other configurations of the described embodiments of the disclosed systems and methods are part of the scope of this disclosure.

It will be appreciated that a variety of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

We claim:

1. A method for forming images in an offset lithographic image forming system, comprising:
cleaning a digitally reproducible imaging surface in the image forming system with a first cleaning device between imaging operations;
cleaning at least one intermediate image transfer surface in the image forming system with a second cleaning device between imaging operations, the second cleaning device being a different cleaning device from the first cleaning device, the at least one intermediate image transfer surface being a surface to which an inked image is transferred from the digitally reproducible imaging surface before being transferred to an output image receiving substrate in the imaging operations;
dampening the digitally reproducible imaging surface with a layer of dampening fluid;
forming a digital pattern in the layer of dampening solution on the digitally reproducible imaging surface;
inking the digital pattern formed on the digitally reproducible imaging surface with ink to produce the inked image;
transferring the inked image from the digitally reproducible imaging surface to the at least one intermediate image transfer surface;
transferring the inked image from the at least one intermediate image transfer surface to an image receiving substrate; and
outputting the image receiving substrate with the inked imaged formed thereon from the image forming system.

2. The method of claim 1, the digitally reproducible imaging surface being patterned with a different digital image between each imaging operation.

3. The method of claim 1, the digitally reproducible imaging surface being a thin compliant plate affixed to a cylinder component in the image forming system.

4. The method of claim 1, the at least one intermediate image transfer surface comprising at least one of a conformable surface on a cylinder or an image receiving surface on an image transfer belt.

5. The method of claim 1, the digital pattern in the layer of dampening fluid being formed using an optical digital image forming device.

6. The method of claim 1, the inking of the digital pattern formed on the digitally reproducible imaging surface being accomplished by an inking device that comprises at least an ink reservoir, an ink transfer cylinder and a third cleaning device, the third cleaning device being a separate cleaning device from the first and second cleaning devices,
the method further comprising cleaning residual ink from the ink forming cylinder after the inking of the digital pattern using the third cleaning device.

7. The method of claim 6, further comprising returning at least a portion of the residual ink cleaned by the third cleaning device to the ink reservoir for reuse.

8. The method of claim 1, further comprising modifying at least one of a viscosity, an adhesiveness or a cohesion of the ink applied to the digital pattern before the transferring of the inked image from the digitally reproducible imaging surface to the at least one intermediate image transfer surface.

9. The method of claim 8, the modifying of the at least one of the viscosity, the adhesiveness or the cohesion of the ink promoting effectiveness in excess of 90% in the transferring of the inked image from the digitally reproducible imaging surface to the at least one intermediate image transfer surface.

10. The method of claim 1, further comprising controlling at least one of an adhesiveness or a cohesion of at least one of the digitally reproducible imaging surface and the at least one intermediate image transfer surface to enhance the transferring of the inked image from the digitally reproducible imaging surface to the at least one intermediate image transfer surface and from the at least one intermediate image transfer surface to the image receiving substrate.

11. The method of claim 10, the controlling the at least one of the adhesiveness or the cohesion of the at least one of the digitally reproducible imaging surface and the at least one intermediate image transfer surface promoting effectiveness in excess of 90% in the transferring of the inked image from the digitally reproducible imaging surface to the at least one intermediate image transfer surface and then to the image receiving substrate.

12. The method of claim 1, the cleaning, dampening, digital image forming and transferring steps all being undertaken by a first module in the image forming system, and all being undertaken separately by at least one second module in the image forming system.

13. A device for forming offset lithographic images, comprising:
a digitally reproducible imaging surface;
a first cleaning device that cleans the digitally reproducible imaging surface between imaging operations;
at least one intermediate image transfer surface that receives an inked image transferred from the digitally reproducible imaging surface and transfers the inked image to an output image receiving substrate;
a second cleaning device that cleans the at least one intermediate image transfer surface between imaging operations, the second cleaning device being a different cleaning device from the first cleaning device;
a dampening device that dampens the digitally reproducible imaging surface with a layer of dampening fluid;
a digital data patterning device that forms a digital pattern in the layer of dampening fluid on the digitally reproducible imaging surface; and
an inking subsystem that applies ink to the digital pattern formed on the digitally reproducible imaging surface to produce the inked image.

14. The device of claim 13, the digitally reproducible imaging surface being patterned with a different digital image between each imaging operation.

15. The device of claim 13, the digitally reproducible imaging surface being a thin compliant plate affixed to a cylinder component.

16. The device of claim 13, the at least one intermediate image transfer surface comprising at least one of a conformable surface on a cylinder or an image receiving surface on an image transfer belt.

17. The device of claim 13, the digital data patterning device comprising an optical digital image forming device.

18. The device of claim 13, the inking subsystem comprising:
an ink chamber;
an ink transfer cylinder that is at least partially submerged in ink in the ink chamber; and
a third cleaning device, the third cleaning device being a separate cleaning device from the first and second cleaning devices,
the third cleaning device being configured to
clean residual ink from the ink transfer cylinder after the applying of the to the digital pattern, and
return at least a portion of the cleaned residual ink to the ink chamber for reuse.

19. The device of claim 18, the third cleaning device comprising a hopper for collecting the cleaned residual ink, and at least one of an auger or a pump associated with the hopper to facilitate the return of the cleaned residual ink to the ink chamber for reuse.

20. The device of claim 13, further comprising a rheology modifying device that modifies at least one of a viscosity, an adhesiveness or a cohesion of the ink applied to the digital pattern before transferring the inked image from the digitally reproducible imaging surface to the at least one intermediate image transfer surface.

21. The device of claim 20, the rheology modifying device partially curing the ink applied to the digital pattern.

22. The device of claim 20, the rheology modifying device modifying the at least one of the viscosity, the adhesiveness or the cohesion of the ink to promote effectiveness in excess of 90% in the transfer of the inked image from the digitally reproducible imaging surface to the at least one intermediate image transfer surface.

23. The device of claim 13, further comprising a mechanism associated with at least one of the digitally reproducible imaging surface and the at least one intermediate image transfer surface that controls at least one of an adhesiveness or a cohesion of the at least one of the digitally reproducible imaging surface and the at least one intermediate image transfer surface to enhance the transferring of the inked image from the digitally reproducible imaging surface to the at least one intermediate image transfer surface and from the at least one intermediate image transfer surface to the output image receiving substrate.

24. The device of claim 23, the mechanism controlling the at least one of the adhesiveness or the cohesion of the at least one of the digitally reproducible imaging surface and the at least one intermediate image transfer surface to promote effectiveness in excess of 90% in the transferring of the inked image from the digitally reproducible imaging surface to the at least one intermediate image transfer surface and then to the output image receiving substrate.

25. An image forming system for forming offset lithographic images on an output image receiving substrate, comprising a plurality of the devices according to claim 13.
